(19) United States
(12) Patent Application Publication
(10) Pub. No.: US 2011/0058041 A1
(43) Pub. Date: Mar. 10, 2011

(54) ROUTE MONITORING SYSTEM FOR A VEHICLE AND METHOD FOR OPERATING THE SAME

(75) Inventor: Andreas Kister, Lorrach (DE)

(73) Assignee: SIEMENS AKTIENGESELLSCHAFT, Muenchen (DE)

(21) Appl. No.: 12/991,821

(22) PCT Filed: May 5, 2009
(86) PCT No.: PCT/EP09/55415

§ 371 Date: Nov. 9, 2010

(30) Foreign Application Priority Data
May 9, 2008 (DE) 10 2008 023 504.0

(51) Int. Cl. H04N 7/18

(52) U.S. Cl. 348/149; 348/E07.085

(57) ABSTRACT

A route monitoring system for a vehicle includes at least one camera, disposed at the route end, for recording video data relating indirectly or directly to a route section on which the vehicle travels, at least one display device for displaying the recorded video data, and a control device which indirectly or directly communicates with the at least one camera and the at least one display device. The control device is configured to display the video data recorded by the camera on the display device. The control device communicates with a vehicle control and/or operations command/control system for operating the vehicle and receives data from the vehicle control and operations command/control system, which data allow the respective vehicle location to be determined. The video data device is configured such that it displays the video data of the at least one camera on the display device depending on the respective vehicle location.

The invention relates to a route monitoring system for a vehicle having at least one camera arranged on the route for recording video data which relate indirectly or directly to a route section on which the vehicle can travel, having at least one display device for displaying the recorded video data and having a control device which is connected indirectly or directly to the at least one camera and to the at least one display device and which is designed such that it displays video data recorded by the camera on the display device.

Such monitoring systems are known to be used in street cars or subways, for example.

The invention is based on the object of specifying a route monitoring system which ensures an even greater degree of security during the operation of the vehicle than the previous route monitoring systems.

The invention achieves this object by means of a route monitoring system having the features according to patent claim 1. Advantageous refinements of the route monitoring system according to the invention are specified in sub claims.

Accordingly, the invention provides for the control device to be connected to a vehicle control system and/or operations management system for operating the vehicle and to receive from the vehicle control system and/or operations management system operational data from which it is possible to ascertain the respective vehicle location of the vehicle, and for the control device to be designed such that it displays the video data from the at least one camera on the display device on the basis of the respective vehicle location.

A fundamental advantage of the route monitoring system according to the invention can be seen in that it uses operational data which are supplied via vehicle control and/or operations management systems for operating the vehicle. The core of the invention thus involves coupling route monitoring systems to vehicle control and/or operations management systems, which are present for vehicle operation anyway, in order to be able to optimize the route monitoring on the basis of the operational data. This coupling of the two systems, that is to say of the route monitoring system on the one hand and of the vehicle control and/or operations management system on the other hand, achieves a synergistic effect, which means the costs can be saved for setting up and maintaining the route monitoring system.

In line with one preferred refinement of the route monitoring system, the control device respectively displays the video data from a route section which is ahead in the direction of travel on the display device, specifically before the vehicle reaches the displayed route section. In this refinement, it is advantageously possible to check whether the route of the vehicle is free of obstacles and can continue to be traveled without hazard.

Preferably, the control device is designed such that it displays the video data on the display device before the route section is visible from the vehicle. If the display device is arranged within the vehicle, the route monitoring system extends the range of vision of the vehicle driver, as described clearly.

It is regarded as particularly advantageous if the control device adaptively matches the display of the video data to the respective vehicle location and the respective vehicle speed, specifically such that at a relatively high speed the route section displayed is further ahead in the direction of travel than at a contrastingly lower speed. The matching of the display to vehicle location and speed allows obstacles or hazards on the route to be recognized so early that the vehicle still has the opportunity to brake in good time and possibly to avoid an accident, for example a collision with a person who is on the route.

In order to allow hazards to be recognized particularly easily and quickly on the display device, it is regarded as advantageous if the control device has an image editing device which adaptively matches the image detail and/or viewing angle displayed on the display device to the respective vehicle location and the respective vehicle speed. By way of example, the image editing device has an electronic zoom function which prompts a zoom effect computationally by converting the image information.

It is also regarded as advantageous if the camera has a zoom function, be it an electronic or an optical zoom function, and the control device controls the zoom function of the camera such that the camera takes the respective speed of the vehicle as a basis for zooming forwards and in so doing records a respective route section before the vehicle reaches the respective route section and/or the respective route section is visible from the vehicle. Preferably, the control device actuates the zoom function such that at a relatively high speed the route section displayed is further ahead in the direction of travel than at a contrastingly lower speed. In the case of this refinement too, it is thus possible to achieve a location-dependent and speed-dependent display on the display device and to reduce the risk of accident.

In line with a further particularly preferred refinement, the route monitoring system has a plurality of cameras arranged on the route which are arranged in succession along the route on which the vehicle can travel and which record successive route sections of the route, wherein the control device is designed such that it displays the video data from the cameras on the display device in chronological succession on the basis of the respective vehicle location and the respective vehicle speed and in so doing respectively switches from one camera to the next before the vehicle reaches the respective route section and/or the respective route section is visible from the vehicle. The switching allows continuous route monitoring to be achieved. In this case, the cameras and/or the image editing devices may also be equipped with an electronic or optical zoom function in order to match the image angle and the image detail on the basis of location and speed in the time periods between switching, that is to say in which the image from a single camera is being used.

Preferably, the control device is respectively switched from one camera to the next such that at a relatively high speed the route section displayed is further ahead in the direction of travel than at a contrastingly lower speed.

The at least one display device may be arranged in the driver's cab of the vehicle and/or in a monitoring control center on the route.

The invention also relates to a method for recording and displaying video data which relate indirectly or directly to a route section on which a vehicle can travel, wherein the method involves video data being recorded using at least one camera, and the video data being displayed on a display device.

For such a method, the invention proposes displaying the video data from the at least one camera on the basis of the respective vehicle location of the vehicle.

For the advantages of the method according to the invention, reference is made to the comments above in connection with the route monitoring system according to the invention, since the advantages of the method essentially correspond to those of the route monitoring system. Advantageous refinements of the method according to the invention are specified in sub claims.

The invention is explained in more detail below with reference to exemplary embodiments, in which, by way of example:

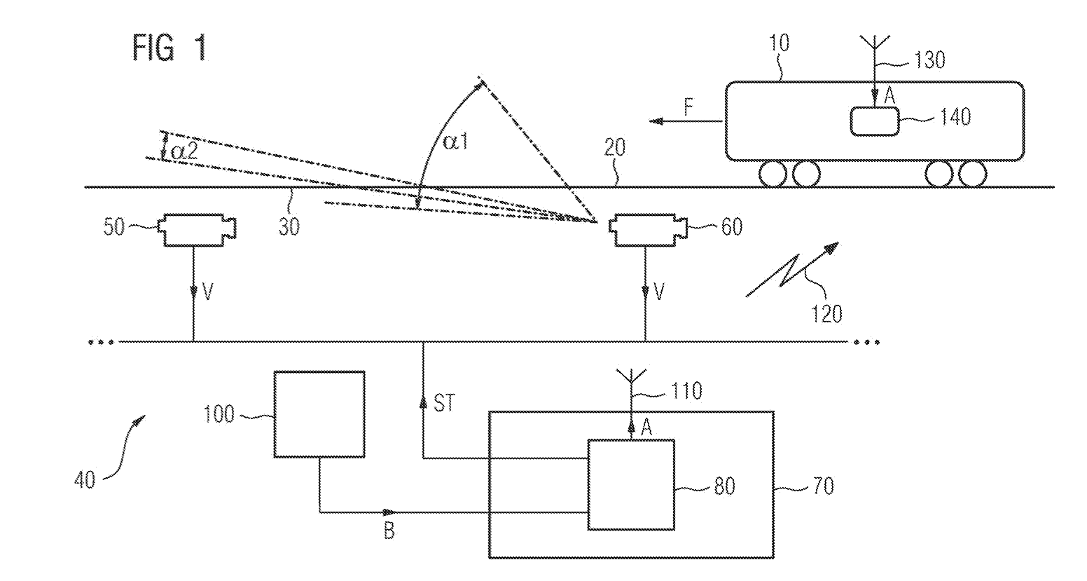

FIG. 1 shows a first exemplary embodiment of a route monitoring system according to the invention in which cameras are equipped with an optical zoom function and a display device is arranged in the driver's cab of the vehicle,

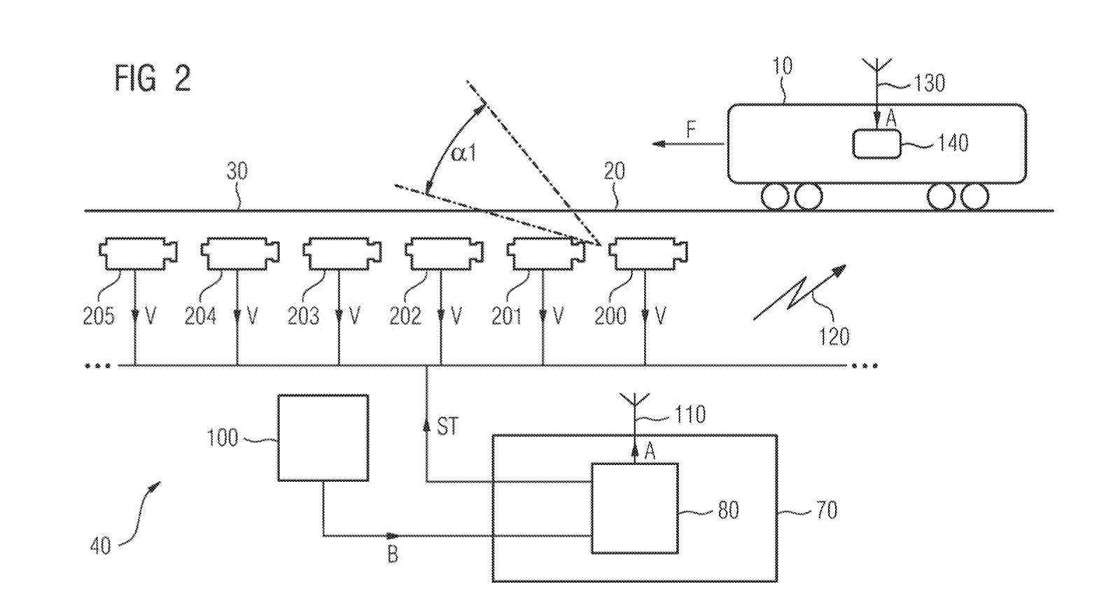

FIG. 2 shows a second exemplary embodiment of a route monitoring system according to the invention in which adaptive matching of the image detail and/or of the viewing angle is carried out in an image editing device, wherein the display device is arranged in the driver's cab of the vehicle,

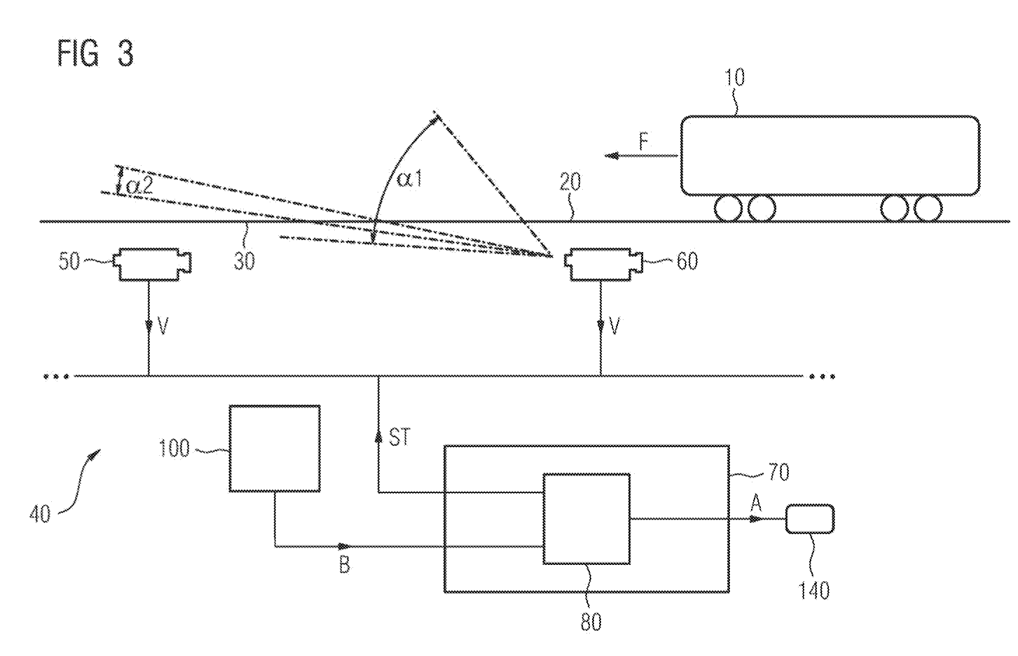

FIG. 3 shows a third exemplary embodiment of a route monitoring system according to the invention in which a display device is arranged in a monitoring control center on the route, and

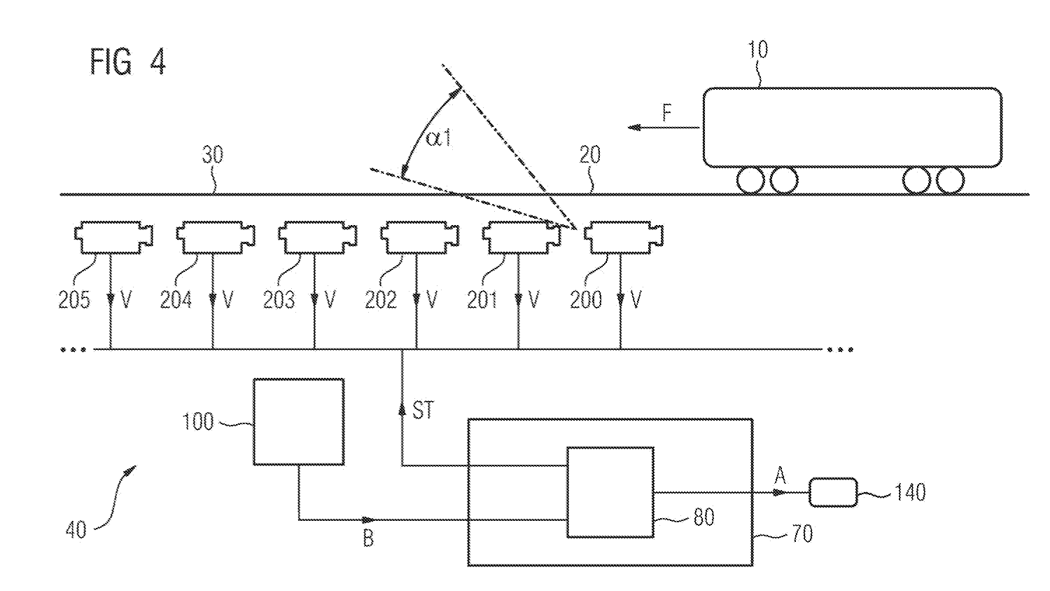

FIG. 4 shows a fourth exemplary embodiment of a route monitoring system according to the invention with a display device in a monitoring control center on the route.

In the figures, the same reference symbols are always used for identical or comparable components for the sake of clarity.

FIG. 1 shows a vehicle 10 traveling in a prescribed direction of travel F on a route 20. The route section ahead in the direction of travel F of the vehicle 10 is denoted by the reference symbol 30.

Along the route 20, a route monitoring system 40 is installed which has a multiplicity of cameras on the route. FIG. 1 representatively shows two of the cameras, which are denoted by the reference symbols 50 and 60. The cameras have a control device 70 connected to them which is equipped with an image editing device 80 for the purpose of image editing. The image editing device 80 is furthermore connected to a vehicle control and/or operations management system 100 which transmits operational data B, which relate to the operation of the vehicle 10 on the route 20, to the image editing device 80.

The control device 70 is equipped with a radio device 110 which has a radio link 120 to a radio device 130 in the vehicle 10. The radio device 130 has a vehicle display device 140 connected to it.

The route monitoring system 40 shown in FIG. 1 can be operated as follows, for example:

The cameras 50 and 60 produce video data V which are sent to the image editing device 80. The image editing device 80 evaluates the video data V and the operational data B from the vehicle control and/or operations management system 100 and produces a display signal A which is transmitted via the radio link 120 to the display device 140 and is displayed thereon.

When forming the display signal A, the image editing device 80 takes account of the respective location of the vehicle 10 on the route 20 and the speed of the vehicle 10, specifically such that a route section 30 which is ahead in the direction of travel F is always displayed on the display device 140. If the vehicle 10 is at high speed during this time, the image editing device 80 will display a route section which is further ahead in the direction of travel F, and if the vehicle is at a lower speed, it will display a route section which is not as far from or closer to the vehicle. Preferably, a route section ahead is displayed before which it is still possible to stop in the event of emergency braking.

In order to be able to take the respective location of the vehicle 10 and the respective speed as a basis for selecting and displaying the optimum route section 30, the cameras 50 and 60 are respectively equipped with a zoom function, which may be an electronic zoom or an optical zoom. In FIG. 1, the zoom action of the camera 60 is symbolized by way of example using viewing angles α1 and α2. It can be seen that the control signal ST can be used to adjust the camera 60 such that, by way of example, a relatively close route section is captured with the image angle α1. Alternatively, the camera 60 can also be operated such that a relatively remote route section is recorded by the camera 60 in a viewing angle which is directed a long way ahead. In summary, the image editing device 80 is thus capable of using the control signal ST to actuate the cameras 50 and 60 individually such that a route section which is ahead of the vehicle in the direction of travel is displayed on the basis of the respective vehicle location and the respective vehicle speed. This allows a vehicle driver to recognize any hazards on the route section ahead early and to prompt emergency braking, for example.

The operational data B which are supplied by the vehicle control and/or operations management system 100 may—as already mentioned—be the respective vehicle location and the respective speed of the vehicle 10. Furthermore, it is also possible for further operational data from the vehicle control and/or operations management system 100 to be used, however: by way of example, it is thus possible to take account of the distance to the next respective station, to possible hazard points, to tunnel entrances, to platform edges, to curves or to route sections behind curve areas in the selection of the image data displayed on the display device 140 and to show sections which are particularly at risk or hazardous separately or to highlight them graphically on the display device.

In the case of the exemplary embodiment shown in FIG. 1, the cameras 50 and 60 are mounted exclusively on the route. Furthermore, it is possible for further cameras to be mounted on the vehicle 10 too and for the video data from said cameras to be additionally taken into account. By way of example, the video data which are captured on the vehicle 10 can be transmitted via the radio link 120 to the control device 70 and hence to the image editing device 80 so that image selection and image processing can be carried out there—as described—on the basis of the operational data B.

It is also possible for the control device 70 and the image editing device 80 to be arranged in the vehicle 10 and for the data which are required for operating the route monitoring system 40 to be transmitted via the radio link 120 to the control device 70. In such an embodiment, the video data V and also the operational data B would thus be transmitted via the radio link 120 to the vehicle 10 which contains the control device 70 with the image editing device 80 in order to evaluate the video data V and the operational data B for the purpose of producing the display signal A.

Furthermore, it is also possible for cameras to be mounted not only at the front of the vehicle 10 but also at the rear of the vehicle 10 in order to allow the route section behind the vehicle to be protected.

FIG. 2 shows a second exemplary embodiment of a route monitoring system 40. In the route monitoring system 40 shown in FIG. 2, there are a plurality of cameras 200 to 205 arranged on the route which are arranged in succession along the route 20 on which the vehicle 10 can travel and which record successive route sections of the route 20. The orientation of the cameras is shown by way of example using the camera 200, from which the recorded image angle α1 is symbolized in FIG. 2.

In the exemplary embodiment shown in FIG. 2, the control device 70 is designed such that it displays the video data V from the cameras 200 to 205 on the display device 140 in chronological succession on the basis of the respective vehicle location and the respective vehicle speed and respectively switches from one camera, for example the camera 200, to the next camera, that is to say in this case the camera 201, before the vehicle 10 reaches the respective route section and/or the respective route section is visible from the vehicle 10.

The switching of the cameras on the basis of the vehicle location and the vehicle speed allows the vehicle driver of the vehicle 10 to display additional image data on the display device 140 which would otherwise not be available to him from the driver's cab. In this way, it is thus possible to recognize hazards early and to initiate emergency braking if necessary.

FIG. 3 shows a third exemplary embodiment of a route monitoring system. The route monitoring system shown in FIG. 3 essentially corresponds to the exemplary embodiment shown in FIG. 1. In contrast to FIG. 1, however, the display device 140 is not arranged on the vehicle 10 but rather is arranged on the route, with the result that a radio link between the vehicle 10 and the control device 70 is not necessary. When the display device 140 is arranged on the route, it can be connected to the control device 70 by wire, for example. Alternatively, it is naturally also possible for there to be a wireless connection between the control device 70 on the route and the display device 140 on the route.

FIG. 4 shows a fourth exemplary embodiment of a route monitoring system. This essentially corresponds to the exemplary embodiment shown in FIG. 2 with the exception that the display device 140 is not arranged on the vehicle 10 but rather is arranged on the route. The display device 140 on the route can be connected to the control device 70 on the route by wire, as shown in FIG. 4, or else alternatively wirelessly.

1-16. (canceled)

17. A route monitoring system for a vehicle, the system comprising:
at least one route-side camera disposed for recording video data that relate indirectly or directly to a route section on which the vehicle can travel;
at least one display device for displaying the video data recorded by said at least one camera; and
a control device connected indirectly or directly to said at least one camera and to said at least one display device;
said control device being connected to receive from a vehicle control and/or operations management system for operating the vehicle operational data from which a respective vehicle location of the vehicle may be ascertained; and
said control device being configured to display the video data recorded by said at least one camera on said display device in dependence on the respective vehicle location.

18. The route monitoring system according to claim 17, wherein said control device is configured to display the video data from a route section lying ahead of the vehicle in a direction of travel thereof.

19. The route monitoring system according to claim 18, wherein said control device is configured to display the video data from a route section before the vehicle reaches the displayed route section.

20. The route monitoring system according to claim 18, wherein said control device is configured to display the video data on the display device before the route section is visible from the vehicle.

21. The route monitoring system according to claim 17, wherein said control device is configured to adaptively match the display of the video data to the respective vehicle location and a respective vehicle speed, such that at a relatively high speed the route section displayed is farther ahead in the direction of travel than at a relatively lower speed.

22. The route monitoring system according to claim 17, wherein said control device includes an image editing device configured to adaptively match an image detail and/or viewing angle displayed on the display device to the respective vehicle location and a respective vehicle speed.

23. The route monitoring system according to claim 17, wherein:
at least one of said camera and an image editing device includes a zoom function; and
said control device is configured to control the zoom function such that the respective speed of the vehicle is taken as a basis for zooming forward and displaying zoomed video data on the display device.

24. The route monitoring system according to claim 23, wherein said control device is configured to control the zoom function such that at a relatively high speed the route section displayed is farther ahead in the direction of travel than at a relatively lower speed.

25. The route monitoring system according to claim 17, wherein:
said at least one camera is one of a plurality of cameras arranged in succession along the route on which the vehicle travels and recording successive route sections of the route; and
said control device being configured to display the video data from the plurality of cameras on the display device in chronological succession based on the respective vehicle location and the respective vehicle speed and in so doing respectively switches from one camera to the next before the vehicle reaches the respective route section and/or before the respective route section is visible from the vehicle.

26. The route monitoring system according to claim 25, wherein said control device is configured to respectively switch from one camera to a following camera such that at a relatively high speed the route section displayed is further ahead in the direction of travel than at a relatively lower speed.

27. The route monitoring system according to claim 17, wherein said at least one display device is disposed in the driver's cab of the vehicle or in a monitoring control center on the route.

28. A method for recording and displaying video data that relate indirectly or directly to a route section on which a vehicle can travel, the method which comprises:
recording video data with at least one camera disposed along the route to be traveled by the vehicle;
displaying the video data on a display device in dependence on a respective vehicle location of the vehicle.

29. The method according to claim 28, which comprises displaying the video data before the vehicle reaches the route section and/or the route section is visible from the vehicle on the route.

30. The method according to claim 28, which comprises adaptively matching the display to the respective vehicle location and the respective vehicle speed.

31. The method according to claim 30, which comprises adaptively matching so that at a relatively high speed the route section displayed is farther ahead in the direction of travel than at a relatively lower speed.

32. The method according to claim 28, which comprises adaptively matching at least one of the displayed image detail and the displayed viewing angle to the respective vehicle location and the respective vehicle speed.

33. The method according to claim 28, which comprises controlling a zoom function on the camera or a zoom function on an image editing device such that the respective speed of the vehicle is taken as a basis for zooming forward to form zoomed video data and displaying the zoomed video data.

34. The method according to claim 28, which comprises:
operating a plurality of route-bound cameras that are arranged in succession along the route on which the vehicle can travel and recording therewith successive route sections of the route; and
displaying video data from the cameras on the display device in chronological succession on based on the respective vehicle location and the respective vehicle speed and thereby switching from one camera to the next before the vehicle reaches the respective route section and/or before the respective route section is visible from the vehicle.
